(19) United States
(12) Patent Application Publication
(10) Pub. No.: US 2014/0325849 A1
(43) Pub. Date: Nov. 6, 2014

(54) FOODSTUFF AND BAIT BALL CUTTER

(71) Applicant: Ian Bellhouse, St Austelle (GB)

(72) Inventor: Ian Bellhouse, St Austelle (GB)

(21) Appl. No.: 14/360,689

(22) PCT Filed: Nov. 21, 2012
(86) PCT No.: PCT/GB2012/052875

§ 371 Date: May 27, 2014

(30) Foreign Application Priority Data
Nov. 25, 2011 (GB) 1120377.5

(51) Int. Cl. A01K 97/04

(52) U.S. Cl. CPC A01K 97/04
USPC 30/272.1

(57) ABSTRACT

A device for cutting balls from foodstuff and comprising: a cutting ring; a bracket rotatably holding the cutting ring and arranged for being pushed into foodstuff with the cutting ring; and a shaft to which the cutting ring is attached and carrying a handle.

### FIELD OF THE INVENTION

The present invention relates to devices for cutting balls of foodstuff and bait and the like. It is particularly concerned with a device for cutting balls from firm to hard vegetables, fruit and squashes, cooked meats including luncheon and sausage meat, dough and cheese and fishing bait, all hereinafter referred to as foodstuff.

### BACKGROUND TO THE INVENTION

Tools exist which with which foodstuff can be cut into balls but these often produce misshapen or partial balls.

### SUMMARY OF THE INVENTION

According to the present invention there is provided a device for cutting balls from foodstuff and bait and the like, the device comprising:

a cutting ring;

a bracket rotatably holding the cutting ring and arranged for being pushed into foodstuff with the cutting ring; and

a shaft to which the cutting ring is attached and carrying a handle.

The cutting ring may comprise a rigid ring of metal, such as stainless steel, or plastic, perhaps reinforced of wall thickness somewhat less than 1 mm or may have formed thereon a cutting edge. Preferably there is a cutting edge extending substantially completely around both edges of the cutting ring. If the cutting edge comprises a bevel this preferably is such that the cutting edge coincides with the inner surface of the ring. The preferred cutting ring is right circular but shapes for producing any body of revolution are possible, for example a right cylinder, or a body which is on side view a diamond, an oval, a flattened sphere, etc.

The bracket advisedly is of U-shape in side view with two arms supporting the cutting ring and is relatively sharp at the outer ends. It is accordingly advantageously formed from stainless steel and preferably has a base plate wherewith the user can push the bracket with the ring into the foodstuff. The base plate may be formed with a dimple sized to accommodate a user's thumb. This confers the added advantage of imparting rigidity to the bracket whilst facilitating the insertion of the device into a foodstuff.

The ring may be arranged to graze the bracket when in vertical array with respect thereto. Preferably however there is a clearance of between 1.0 and 2.0 mm which serves to assist in ensuring the required resulting foodstuff shape and can also enable the device to operate beneath a skin or a perhaps undesirable outer surface.

The cutting ring and perhaps the bracket may be Teflon coated.

The handle, preferably rigidly mounted on the shaft, may be disc shaped with the disc aligned or coplanar with the cutting ring so as to indicate the position and configuration of the ring within the foodstuff.

The shaft includes, at the side of the ring remote from the main body thereof, a spindle which also engages the bracket. The bracket may be arranged so that the shaft is a snap fit therein, perhaps by the provision of a keyway running from the outer edge of one of the bracket arms. A shaft diameter of the order of 2 mm is usually sufficient to ensure adequate rigidity whilst being susceptible of being pushed into the foodstuff. To augment the latter facility however the shaft may be formed with somewhat cutting edges, normal to the plane of the cutting ring, at least adjacent the bracket.

Typical dimensions to the device are an overall length of 9.0 to 11.0 cm and a cutting ring size of 2.0 to 3.0 cm. Indeed the device may constitute one of a set having rings of, for example, 2.0 cm, 2.3 cm, 2.5 cm and 3 cm. Moreover the set may comprise additionally devices with non-circular rings preferably within a similar range of dimensions. For creating balls of bait however the cutting ring diameter may be of the order of 12 mm.

In use, the device is pressed into a foodstuff by pressing the bracket base plate into the foodstuff with the cutting ring substantially flat to the food surface. When the base plate has engaged the foodstuff surface the handle is turned at least one full revolution to cut the ball shape. Then, perhaps with the cutting ring in a vertical position relative to the bracket the device may be withdrawn from the food stuff bringing the ball with it.

### BRIEF DESCRIPTION OF THE DRAWINGS

Embodiments of the invention will now be described by way of example with reference to the accompanying drawings, of which:

FIG. 1 is an isometric view of a foodstuff ball cutter;

FIG. 2 is an exploded view illustrating the components of the cutter shown in FIG. 1, with FIG. 2a being a section on IIa-IIa;

FIG. 3 is a further isometric view of the device;

FIG. 4 is a section on IV-IV in FIG. 3, except that a handle is shown as a disk in the form of a washer; and

FIG. 5 is a sketch of the device in operation.

### DESCRIPTION OF PREFERRED EMBODIMENTS

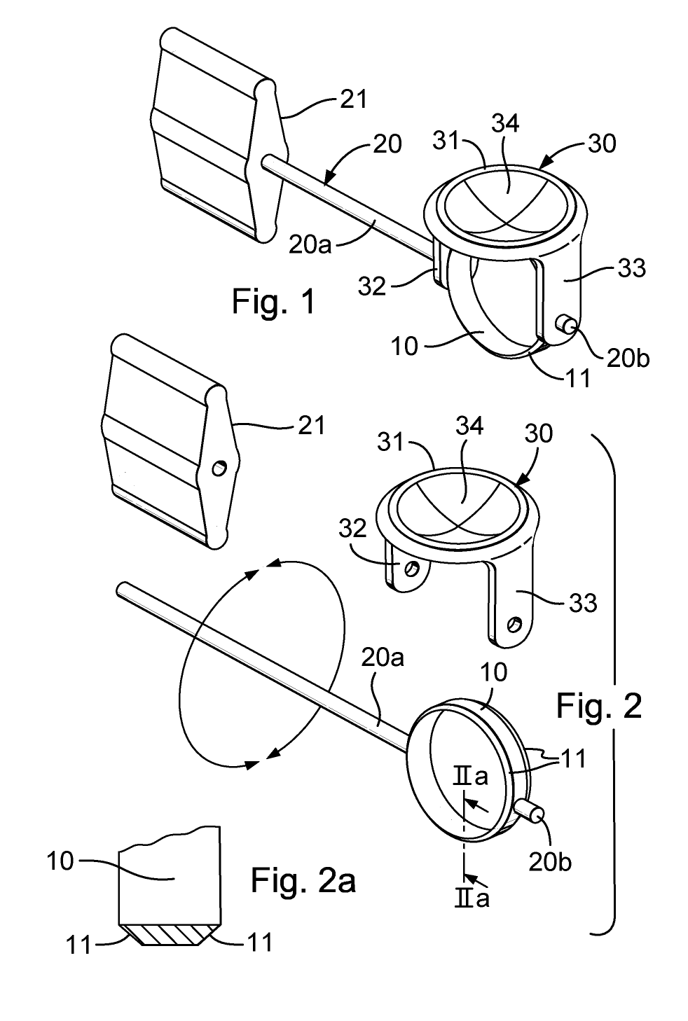

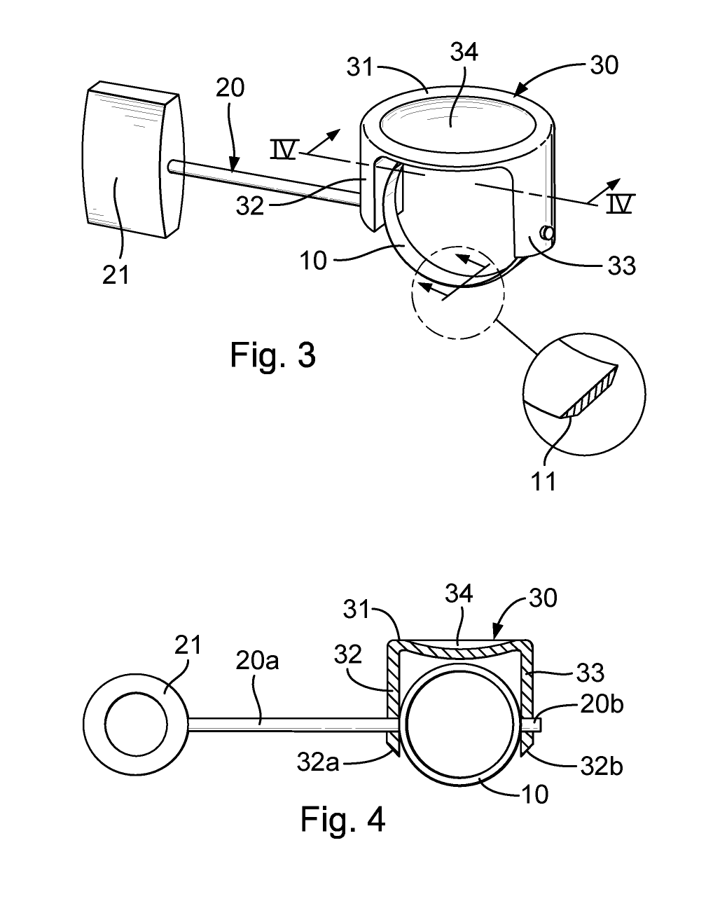

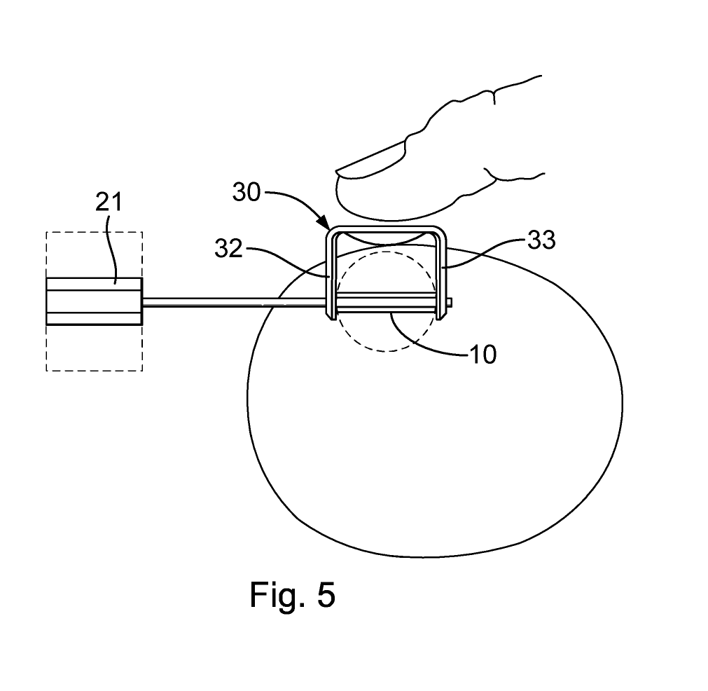

The device shown in FIGS. 1 to 5 comprises a cutting ring 10, a shaft 20 to which the cutting ring 10 is rigidly mounted, a handle 21 on the shaft 20, distal from the cutting ring 10, and a bracket 30.

The cutting ring 10 has a bevel 11 formed on both edges thereof so as to present a cutting edge contiguous with the inner surface of the ring.

The shaft 20 comprises a main portion 20a and a spindle portion 20b rigidly attached at diametrically opposite sides of the ring 10.

The handle 21 is shown as resembling a bicycle foot pedal but in FIG. 4 as a disk, in fact a washer, of diameter similar to that of the cutting ring 10. The handle 21 is coplanar with the cutting ring 10.

The bracket 30 is substantially U-shaped in side elevation, comprising a base plate portion 31 and two arm members 32 and 33. The shaft portion 20a passes through a hole in the arm member 32 and the spindle portion 20b is received in an equivalent hole in the arm member 33. The outer or upper edges 32a, 32b of the arm members are sharpened, with a cutting edge contiguous with the inner surface of the arms 32, 33. The bracket base plate portion 31 has a dimple 34 formed therein.

In a particular embodiment of the device the cutting ring 10, the bracket 30 and the shaft 20 are formed from stainless steel and the device is one of a set having cutting rings 10 of different sizes, in fact 20 mm, 23 mm, 25 mm and 30 mm, with the brackets 30 sized accordingly so that there is a 1.0 mm gap between the cutting ring 10 and the dimple 34 when the cutting ring 10 is in the vertical position. The bracket 30 has a wall thickness of the order of 0.8 mm. The overall length of the device, of which the main portion is a rod of outside diameter 2.0 mm so that even the shaft readily enters the foodstuff, is from 9.0 to 11.0 cm dependent upon the size of the ring. In use, the device is pressed into a foodstuff by pressing the bracket base plate into the foodstuff with the cutting ring substantially flat to the food surface. When the base plate has engaged the foodstuff surface the handle is turned at least one full revolution to cut the ball shape. Then, with the cutting ring in a vertical position relative to the bracket the device is withdrawn from the food stuff bringing the ball with it.

1-23. (canceled)

24. A device for cutting balls from foodstuff and comprising:
a cutting ring;
a bracket rotatably holding the cutting ring and arranged for being pushed into foodstuff with the cutting ring; and
a shaft to which the cutting ring is attached and carrying a handle.

25. A device as claimed in claim 24 and wherein the cutting ring comprises a rigid ring of metal.

26. A device as claimed in claim 24 and wherein the cutting ring is formed from stainless steel.

27. A device as claimed in claim 24 and wherein the cutting ring has formed thereon a cutting edge.

28. A device as claimed in claim 27 and wherein the cutting edge comprises a bevel such that the cutting edge coincides with the inner surface of the ring.

29. A device as claimed in claim 24 and wherein the cutting ring is shaped for producing any one of bodies of revolution, including a sphere, a right cylinder, and a body which is on side view a diamond, an oval, and a flattened sphere.

30. A device as claimed in claim 24 and wherein the bracket is of U-shape with two arms supporting the cutting ring and is relatively sharp at the outer ends.

31. A device as claimed in claim 24 and wherein the bracket has a base plate wherewith the user can push the bracket with the ring into the foodstuff.

32. A device as claimed in claim 31 and wherein the base plate is formed with a dimple sized to accommodate a user's thumb.

33. A device as claimed in claim 24 and wherein the handle on the shaft is disc shaped with the disc coplanar with the cutting ring so as to indicate the position and configuration of the ring within the foodstuff.

34. A device as claimed in claim 24 and wherein the shaft includes, at the side of the ring remote from the main body thereof, a spindle which also engages the bracket.

35. A device as claimed in claim 24 and wherein the bracket is arranged so that the shaft is a snap fit therein.

36. A device as claimed in claim 24 and having a shaft diameter of the order of 2 mm.

37. A device as claimed in claim 24 and wherein the shaft is formed with somewhat cutting edges, normal to the plane of the cutting ring, at least adjacent the bracket.

38. A device as claimed in claim 24 and having an overall length of 9.0 to 11.0 cm and a cutting ring size of 2.0 to 3.0 cm.

39. A device as claimed in claim 24 and constituting one of a set of such devices.

40. A device for cutting balls from foodstuff and comprising:
a cutting ring formed of metal and having formed thereon a cutting edge;
a bracket rotatably holding the cutting ring and arranged for being pushed into foodstuff with the cutting ring, the bracket being of U-shape with two arms supporting the cutting ring which are relatively sharp at the outer ends thereof; and a base plate wherewith the user can push the bracket with the ring into the foodstuff; and
a shaft to which the cutting ring is attached and which is mounted to the shaft;
a handle mounted on the shaft and coplanar with the cutting ring.

41. A device as claimed in claim 40 and wherein the base plate is formed with a dimple sized to accommodate a user's thumb.

42. A device as claimed in claim 40 and which is one of a set, the devices in the set having cutting rings of the order of 2.0 cm, 2.3 cm, 2.5 cm and 3 cm diameter.

43. A device as claimed in claim 40 and having an overall length of 9.0 to 11.0 cm and a cutting ring size of 2.0 to 3.0 cm and a wall thickness less than 1 mm.
